(19) United States
(12) Patent Application Publication
(10) Pub. No.: US 2024/0386894 A1
(43) Pub. Date: Nov. 21, 2024

(54) INFORMATION PROCESSING APPARATUS, INFORMATION PROCESSING METHOD, AND PROGRAM

(71) Applicant: NTT TECHNOCROSS CORPORATION, Tokyo (JP)

(72) Inventors: Takaaki FUKUTOMI, Tokyo (JP); Sanae WADA, Tokyo (JP); Kenichi MACHIDA, Tokyo (JP)

(73) Assignee: NTT TECHNOCROSS CORPORATION, Tokyo (JP)

(21) Appl. No.: 18/695,763

(22) PCT Filed: Jan. 14, 2022
(86) PCT No.: PCT/JP2022/001147

§ 371 Date: Mar. 26, 2024

(30) Foreign Application Priority Data
Oct. 11, 2021 (JP) 2021-166652

(51) Int. Cl. G10L 15/26; G10L 15/30

(52) U.S. Cl. CPC G10L 15/26; G10L 15/30

(57) ABSTRACT

An information processing apparatus comprising a processor configured to execute operations comprising: specifying a scene, wherein the scene represents a conversation between two or more persons when an utterance is made based on a character string, and the character string represents the utterance in the conversation; and creating visualization information, wherein the visualization information visualizes a first time series of character strings in the conversation, a second time series of scenes in the conversation, and a relationship between the scenes.

### TECHNICAL FIELD

The present invention relates to an information processing apparatus, an information processing method, and a program.

### BACKGROUND ART

In contact centers (also referred to as call centers), work called after call work (ACW) is generally performed. ACW refers to a post-processing work that is performed after the telephone call with a customer is completed, such as creating a record of the call, ordering goods or services, and the like.

ACW is an important work, but is time during which customer service is not available, so there is a need to improve the efficiency of ACW. In contrast, as a technique for improving efficiency in creating response records, a technique is known in which utterances in a call with a customer are converted into text by a voice recognition technique and an utterance scene is specified from the text (e.g., Patent Document 1). Here, the scene is a scene in a conversation performed between an operator and a customer, and includes, for example, “opening” indicating a scene of a first greeting or the like, “inquiry identification” indicating a scene of identifying inquiry contents from the customer, “response” indicating a case of responding to the inquiry contents, “closing” indicating a scene of a final greeting or the like, and the like.

### RELATED ART DOCUMENT

### Patent Document

Patent Document 1: WO 2020/036189

### SUMMARY OF THE INVENTION

### Problems to be Solved by the Invention

However, when conversations of various topics are performed during a call, various scenes are specified, and as a result, it is difficult to identify a relationship between the scenes (e.g., a structural relationship between the scenes, an association between the scenes, or the like). Therefore, it is difficult to identify conversation contents of the entire call, and for example, it may take time to create response records.

An embodiment of the present invention has been made in view of the above, and an object of the embodiment is to support identification of conversation contents.

### Means for Solving the Problems

According to an embodiment, there is provided an information processing apparatus that includes a specifying unit configured to specify a scene representing a scene in a conversation between two or more persons when an utterance is made based on a character string representing the utterance in the conversation; and a creating unit configured to create visualization information for visualizing a time series of character strings in the conversation, a time series of scenes in the conversation, and a relationship between the scenes.

### Effects of the Invention

According to an embodiment, it is possible to support the identification of conversation contents.

### BRIEF DESCRIPTION OF THE DRAWINGS

FIG. 1 is a diagram illustrating an example of an overall configuration of a contact center system according to a first embodiment.

FIG. 2 is a diagram illustrating an example of a functional configuration of the contact center system according to the first embodiment.

FIG. 3 is a diagram illustrating an example of a hierarchical structure definition included in definition information.

FIG. 4 is a diagram illustrating an example of association definition included in definition information.

FIG. 5 is a flowchart illustrating an example of a call visualization process according to the first embodiment.

FIG. 6 is a diagram (part 1) illustrating an example of an operator screen on which a hierarchical structure of a scene is visualized.

FIG. 7 is a diagram (part 2) illustrating an example of an operator screen on which the hierarchical structure of scenes is visualized.

FIG. 8 is a diagram illustrating an example of an operator screen on which an association between scenes is visualized.

FIG. 9 is a diagram illustrating an example of an operator screen on which the association between scenes and supplementary information are visualized.

FIG. 10 is a diagram schematically illustrating a specific example of a modification.

FIG. 11 is a diagram illustrating an example of a functional configuration of a contact center system according to the second embodiment.

FIG. 12 is a flowchart illustrating an example of a call visualization process according to the second embodiment.

FIG. 13 is a diagram illustrating an example of an operator screen on which a talk script corresponding to a scene is visualized as support information.

FIG. 14 is a diagram illustrating an example of an operator screen on which a next scene candidate and its transition probability are visualized as support information.

### EMBODIMENT OF THE INVENTION

Hereinafter, a first embodiment and a second embodiment will be described as embodiments of the present invention. In each embodiment, a contact center system 1 that can support an operator at a contact center in identification of conversation contents (i.e., call contents) in a call with a customer when the operator at the contact center identifies conversation contents will be described below. However, the contact center is an example, and the embodiments of the present invention can be similarly applied to other cases, in addition to the contact center. For example, the embodiments of the present invention can be applied to a case of identification of communication contents of a call of a person in charge who works in an office or the like. Further, a call is not limited to being held between two persons, and a call may be held among three or more persons.

Further, in the following description, it is assumed that an operator at the contact center performs voice communication with a customer, but the present invention is not limited to this example. The present invention is also applicable to cases where text chats (including those that can send and receive stamps and attached files in addition to text), video calls, etc. are made.

### First Embodiment

First, a first embodiment will be described. In the present embodiment, a case will be described in which a relationship between scenes is also visualized to facilitate identification of a content of a call, mainly for the purpose of improving the efficiency of ACW such as the creation of response records. Here, the ACW is generally work relating to a post-process performed after the end of a call with a customer (i.e., the ACW takes place while being offline.). The ACW includes, for example, ordering of a product or a service in addition to the creation of the response records.

### <Overall Configuration>

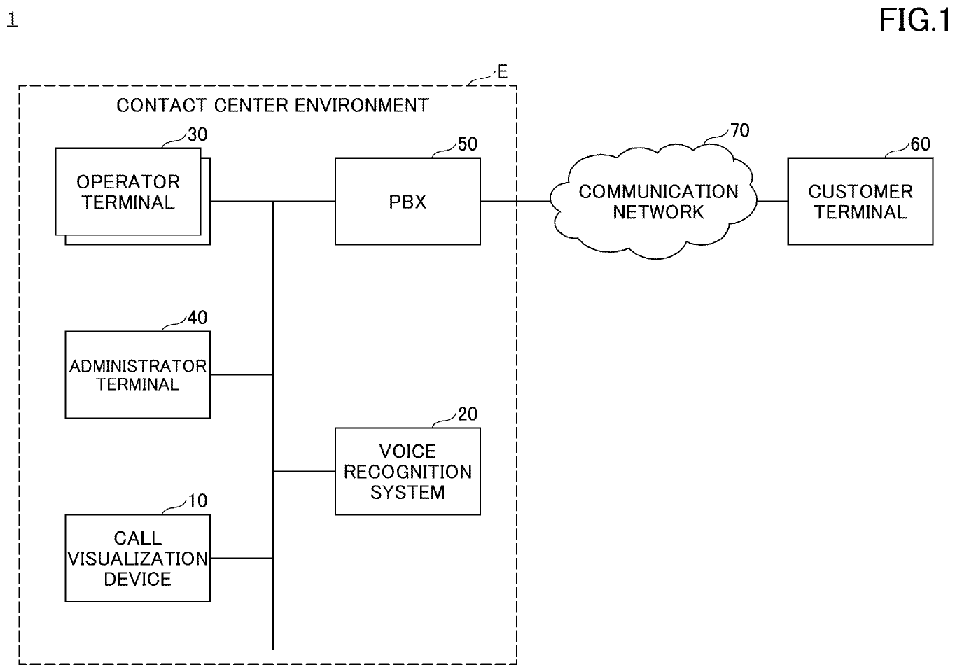

FIG. 1 illustrates an example of an overall configuration of a contact center system 1 according to the present embodiment. As illustrated in FIG. 1, the contact center system 1 according to the present embodiment includes a call visualization apparatus 10, a voice recognition system 20, operator terminals 30, an administrator terminal 40, a private branch exchange (PBX) 50, and a customer terminal 60. Here, the call visualization apparatus 10, the voice recognition system 20, the operator terminals 30, the administrator terminal 40, and the PBX 50 are installed in a contact center environment E which is a contact center system environment. The contact center environment E is not limited to a system environment in the same building, and may be, for example, a system environment in a plurality of buildings geographically separated from each other.

The call visualization apparatus 10 creates information for visualizing utterances in a call between a customer and an operator, scenes of the utterances, and relationships between the scenes (hereinafter also referred to as visualization information), and send the visualization information to the operator terminal 30 (or may be the administrator terminal 40). The visualization information is information for displaying an operator screen or the like, which will be described later, on a display of the operator terminal 30, and is screen information defined by, for example, Hypertext Markup Language (HTML) or Cascading Style Sheets (CSS).

The voice recognition system 20 performs voice recognition on a call between a customer and an operator, and converts the utterances during the call into text (character string). Here, in the following, it is assumed that voice recognition is performed on both of the utterance of the customer and the utterance of the operator, but the present invention is not limited thereto, and for example, voice recognition may be performed on only one of the utterances.

The operator terminal 30 is a terminal of various types such as a personal computer (PC) used by an operator who responds to an inquiry from a customer, and functions as an Internet Protocol (IP) telephone.

The administrator terminal 40 is various terminals such as a PC used by an administrator who manages operators (such an administrator is also referred to as a supervisor).

The PBX 50 is a telephone exchange (IP-PBX), and is connected to a communication network 70 including a VOIP (Voice over Internet Protocol) network and a PSTN (Public Switched Telephone Network).

The customer terminal 60 is various terminals such as a smartphone, a mobile phone, and a fixed telephone used by a customer.

The overall configuration of the contact center system 1 illustrated in FIG. 1 is an example, and other configurations may be adopted. For example, in the example illustrated in FIG. 1, the call visualization apparatus 10 is included in the contact center environment E (i.e., the call visualization apparatus 10 is an on-premise type), but all or some of the functions of the call visualization apparatus 10 may be implemented by a cloud service or the like. Similarly, in the example illustrated in FIG. 1, the voice recognition system 20 is an on-premise type, but all or some of the functions of the voice recognition system 20 may be implemented by a cloud service or the like. Similarly, in the example illustrated in FIG. 1, the PBX 50 is an on-premise telephone exchange, but may be implemented by a cloud service.

In addition, although the operator terminal 30 is described as functioning as an IP telephone, for example, a telephone may be included in the contact center system 1 separately from the operator terminal 30.

### <Functional Configuration>

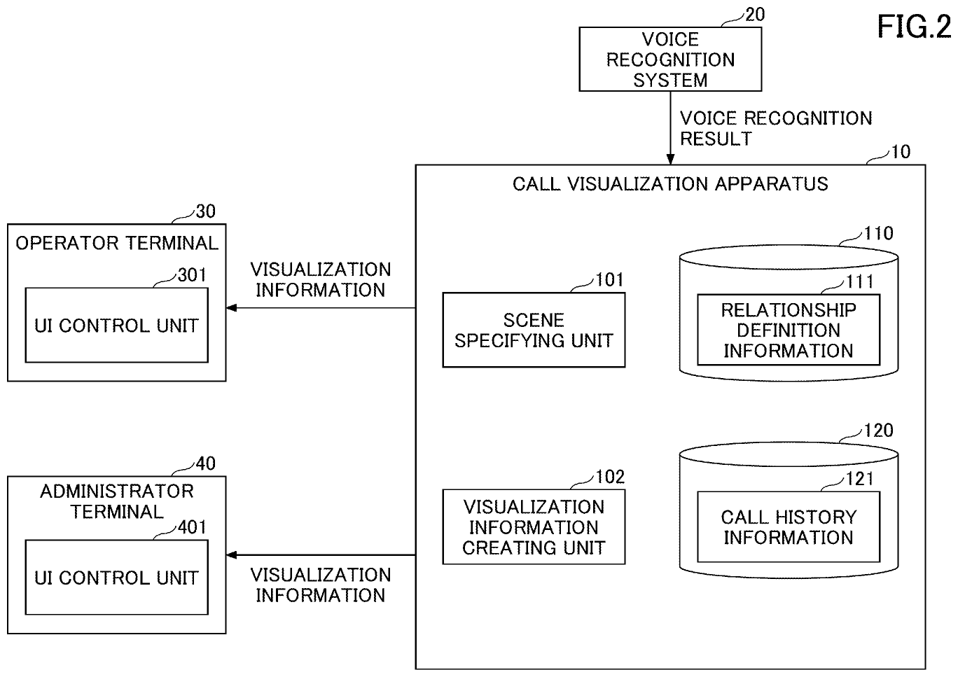

FIG. 2 illustrates functional configurations of the call visualization apparatus 10, the operator terminal 30, and the administrator terminal 40 included in the contact center system 1 according to the present embodiment.

### <<Call Visualization Apparatus 10>>

As illustrated in FIG. 2, the call visualization apparatus 10 according to the present embodiment includes a scene specifying unit 101 and a visualization information creating unit 102. These units are implemented by, for example, a process in which one or more programs installed in the call visualization apparatus 10 are executed by a processor such as a central processing unit (CPU). The call visualization apparatus 10 according to the present embodiment includes a relationship definition information storage unit 110 and a call history information storage unit 120. Each of these units can be implemented by a storage unit such as a hard disk drive (HDD), a solid state drive (SSD), or a flash memory.

The scene specifying unit 101 specifies each utterance scene in the call based on the voice recognition result (i.e., the text indicating the utterance of the customer and the text indicating the utterance of the operator) for the call between the customer and the operator. Note that a known scene identification technique or scene classification technique may be used to identify the utterance scene. For example, each utterance scene may be specified using the technique described in Patent Document 1.

The scene specifying unit 101 stores time-series information in which a speaker (a customer or an operator), text indicating utterance, and an utterance scene are associated with each other in the call history information storage unit 120 as the call history information 121. The call history information 121 also includes information such as a call ID for identifying a call, an operator ID of an operator who has responded to the call, and a call date and time of the call.

Here, the scene is a scene in a conversation performed between the operator and the customer, and what kind of scene is present is defined in advance. Typical scenes include, for example, “opening” representing a scene of a first greeting or the like, “inquiry identification” representing a scene of identifying a content of an inquiry from a customer, “response” representing a scene of responding to the content of the inquiry, and “closing” representing a scene of a final greeting or the like.

An utterance is a single voice (or a text representing a voice recognition result of a voice). The range of one break is optionally configurable, and for example, the end-of-speech unit described in Patent Document 1 may be used as one break. The end-of-speech unit is a single unit that the speaker desires to talk about, and is, for example, a range that is delimited by a period “.”, a question mark “?”, or the like when a voice is converted into text by voice recognition.

The visualization information creating unit 102 creates visualization information for visualizing text representing an utterance of each speaker, an utterance scene, and a relationship between the scenes, based on relationship definition information 111 stored in the relationship definition information storage unit 110. Then, the visualization information creating unit 102 transmits the visualization information to the operator terminal 30 (or the administrator terminal 40). The relationship definition information 111 is information that defines a relationship between scenes (e.g., a structural relationship between scenes, an association between scenes, or the like). A specific example of the relationship definition information 111 will be described later.

The relationship definition information storage unit 110 stores the relationship definition information 111. The call history information storage unit 120 stores call history information 121. The relationship definition information 111 is created in advance and stored in the relationship definition information storage unit 110.

The relationship definition information 111 includes at least a hierarchical structure definition that defines a hierarchical structure relationship (parent-child relationship) between scenes and an association definition that defines an association between scenes.

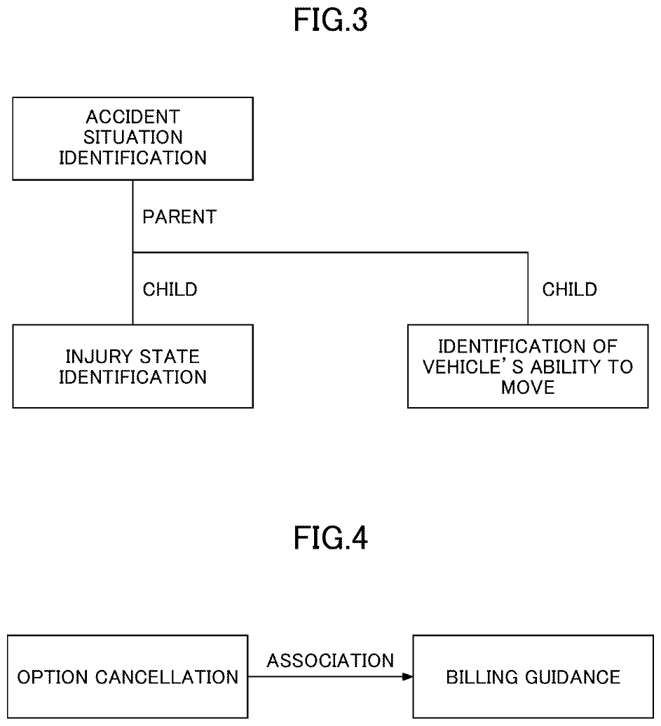

An example of the hierarchical structure definition is illustrated in FIG. 3. In the example illustrated in FIG. 3, the structural relationship of three scenes, “accident situation identification”, “injury state identification”, and “identification of vehicle's ability to move”, is defined. Specifically, a relationship is defined in which “accident situation identification” is a parent, and “injury state identification” and “identification of vehicle's ability to move” are children. Such a parent-child relationship is defined based on, for example, a semantic inclusion relationship between scenes, a conceptual hierarchical relationship, or the like.

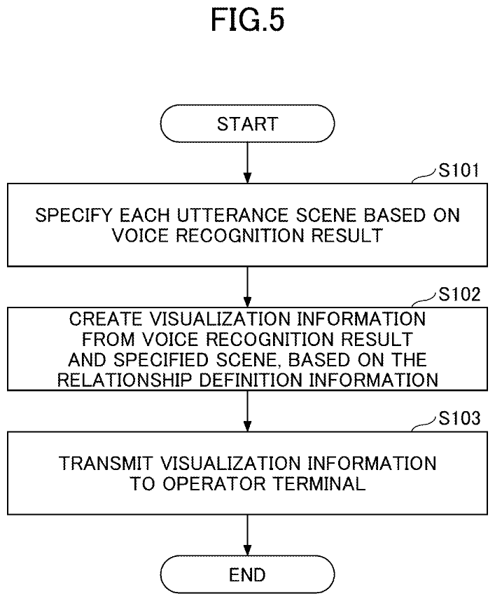

An example of the association definition is illustrated in FIG. 4. In the example illustrated in FIG. 4, an association between two scenes “option cancellation” and “billing guidance” is defined. Specifically, a relationship representing an association is defined such that “billing guidance” also needs to appear when “option cancellation” appears during a call. Such an association is defined based on, for example, a dependency between scenes. The dependency between scenes means a relationship that when a certain scene appears during a call, another scene also needs to appear.

In addition to the hierarchical structure definition and the association definition, various relationships may be defined in the relationship definition information 111. For example, in order to connect the identical scenes when a plurality of the identical scenes appear, a relationship that the identical scenes are associated with each other may be defined as the relationship definition. Further, for example, a parallel relationship, an opposite relationship indicating that the relationship is semantically opposite, or the like may be defined. In addition, for example, a relationship indicating that a scene interrupted in the middle and a scene in which the interrupted scene is resumed are associated with each other may be defined. The relationship between the scene interrupted in the middle and the scene resumed from the interrupted scene will be described in detail in a modification described below.

### <<Operator Terminal 30>>

As illustrated in FIG. 2, the operator terminal 30 according to the present embodiment includes a UI control unit 301. The UI control unit 301 is implemented by, for example, a process in which one or more programs installed in the operator terminal 30 are executed by a processor such as a CPU.

The UI control unit 301 displays an operator screen, which will be described later, on the display based on the visualization information received from the call visualization apparatus 10.

### <<Administrator Terminal 40>>

As illustrated in FIG. 2, the administrator terminal 40 according to the present embodiment includes a UI control unit 401. The UI control unit 401 is implemented by, for example, a process in which one or more programs installed in the administrator terminal 40 are executed by a processor such as a CPU.

The UI control unit 401 displays a screen similar to the operator screen (which may be referred to as a supervisor screen or an administrator screen), which will be described later, based on the visualization information received from the call visualization apparatus 10.

### <Call Visualization Processing>

Hereinafter, for the purpose of improving the efficiency of the ACW, a process of displaying the operator screen on the display of the operator terminal 30 after the end of a call with a customer and visualizing a content of the call will be described with reference to FIG. 5. In the following description, i that the voice recognition system 20 performs voice recognition on a call between a customer and an operator, and a voice recognition result is transmitted to the call visualization apparatus 10.

First, the scene specifying unit 101 specifies each utterance scene in the call based on the voice recognition result received from the voice recognition system 20 (step S101). Thus, the call history information 121 in which a speaker (a customer or an operator), text representing an utterance, and an utterance scene are associated with each other is created and stored in the call history information storage unit 120. As described above, the scene specifying unit 101 may specify each utterance scene using a known scene specifying technique or scene classification technique such as a technique described in Patent Document 1, for example.

Next, the visualization information creating unit 102 creates visualization information for visualizing text representing an utterance of each speaker, an utterance scene, and a relationship between the scenes, based on the relationship definition information 111 stored in the relationship definition information storage unit 110 (step S102).

Then, the visualization information creating unit 102 transmits the visualization information created in step S102 to the operator terminal 30 of an operator who has responded to the call (step S103). Accordingly, an operator screen, which will be described later, is displayed on the display of the operator terminal 30 by the UI control unit 301 based on the visualization information received from the call visualization apparatus 10.

Although the visualization information is transmitted to the operator terminal 30 in step S103, the visualization information may be transmitted to the administrator terminal 40 in response to a request from the administrator terminal 40, for example. In this case, the supervisor screen is displayed on the display of the administrator terminal 40 by the UI control unit 401 based on the visualization information received from the call visualization apparatus 10.

### <Operator Screen>

Hereinafter, as an example, an operator screen displayed on the display of the operator terminal 30 will be described.

### Operator Screen Example 1-1

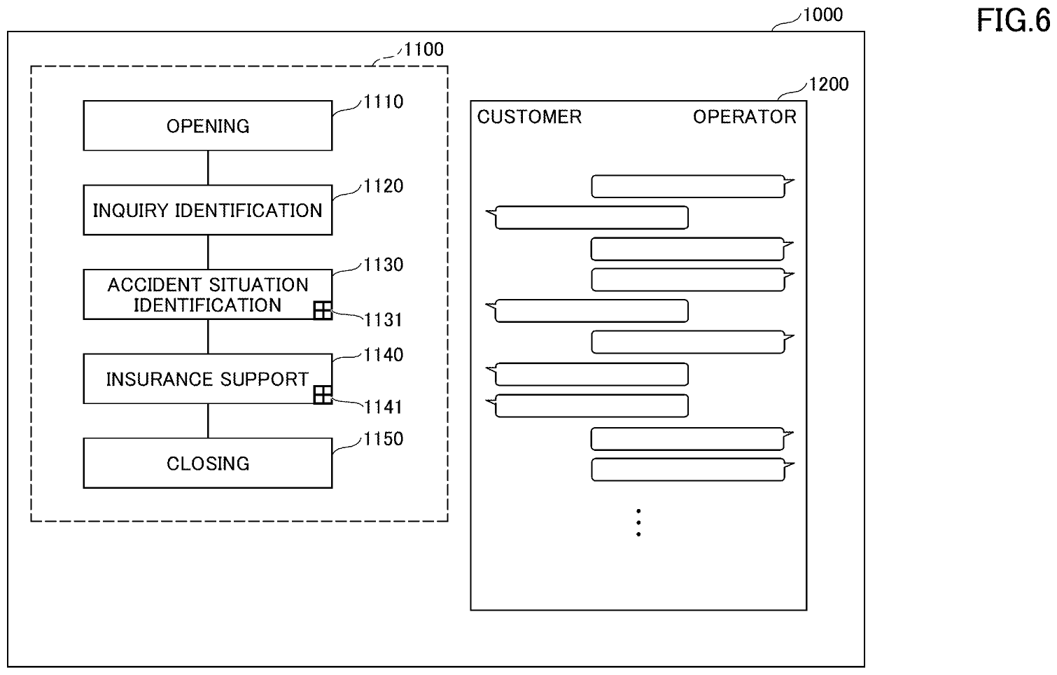

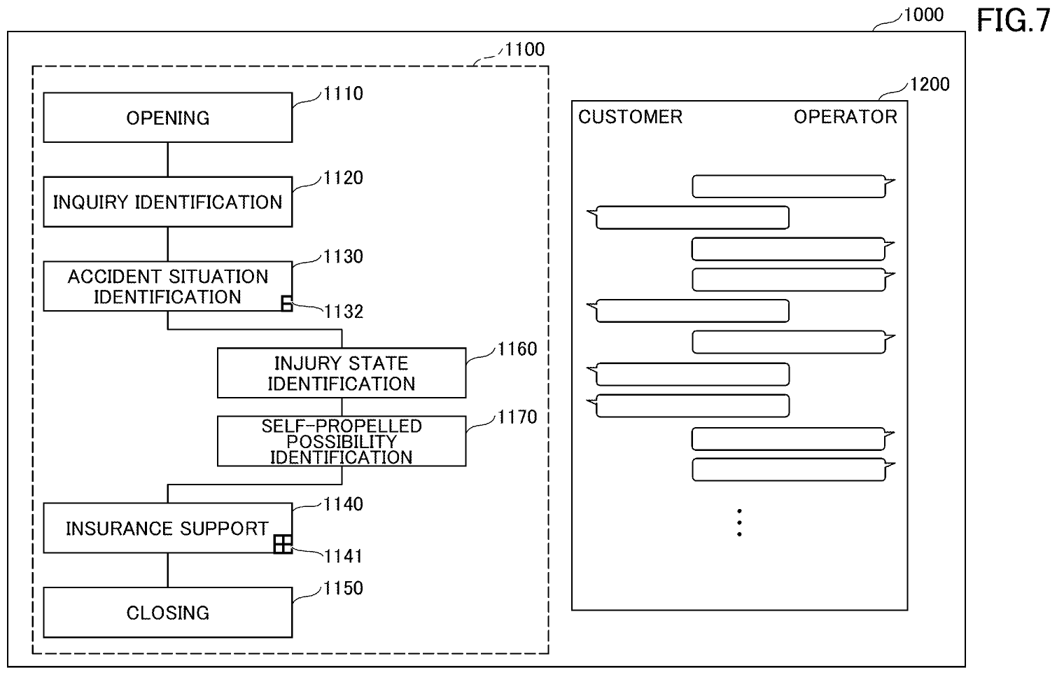

It is assumed that visualization information for visualizing a hierarchical structure of a relationship between scenes is generated based on the relationship definition information 111 stored in the relationship definition information storage unit 110. An example of an operator screen displayed by the UI control unit 301 based on the visualization information will be described with reference to FIGS. 6 and 7.

An operator screen 1000 illustrated in FIG. 6 includes a scene display field 1100 and an utterance display field 1200. The scene display field 1100 displays scene buttons corresponding to scenes specified during a call in chronological order. The utterance display field 1200 displays utterances of a scene corresponding to a scene button selected from the scene display field 1100 in chronological order.

In the example illustrated in FIG. 6, the scene display field 1100 displays a scene button 1110 corresponding to “opening”, a scene button 1120 corresponding to “inquiry identification”, a scene button 1130 corresponding to “accident situation identification”, a scene button 1140 corresponding to “insurance support”, and a scene button 1150 corresponding to “closing”.

The scene button 1130 corresponding to “accident situation identification” is provided with an unfold button 1131 for displaying a scene button corresponding to a scene having “accident situation identification” as a parent (in other words, a child scene of “accident situation identification”). Similarly, the scene button 1140 corresponding to “insurance support” is provided with an unfold button 1141 for displaying a scene button corresponding to a scene having “insurance support” as a parent (in other words, a child scene of “insurance support”).

For example, when the unfold button 1131 is selected by the operator, as illustrated in FIG. 7, a scene button 1160 corresponding to the scene “injury state identification” having “accident situation identification” as a parent and a scene button 1170 corresponding to the scene “identification of vehicle's ability to move” having “accident situation identification” as a parent are displayed. This indicates that “accident situation identification” appears as a scene during the call, “injury state identification” appears next, and “identification of vehicle's ability to move” appears thereafter in sequence. At this time, the unfold button 1131 is changed to a fold button 1132 for returning to the state illustrated in FIG. 6 by hiding the scene button 1160 and the scene button 1170.

As described above, in the operator screen according to the present embodiment, when a scene having a parent-child relationship is present among scenes specified during a call, and one or more child scenes appear immediately after the parent scene, the child scenes are hidden and the unfold button for displaying these child scenes is assigned to the scene button corresponding to the parent scene. Thus, even when the scene structure during a call has a complicated hierarchical structure, only the scene of the highest hierarchy is displayed, so that the operator can easily identify the scene structure of the entire call.

Further, when the operator desires to check a more detailed scene structure (i.e., a scene structure including a scene of a lower hierarchy), the operator can display a child scene of the scene to which the unfold button is assigned by pressing the unfold button. Therefore, the operator can easily identify the scene structure of the entire call and can also check a more detailed scene structure, if necessary.

In the example illustrated in FIGS. 6 and 7, the “injury state identification” and the “identification of vehicle's ability to move” are present as the child scenes of the “accident situation: identification”, and the hierarchical structure between the scenes is two layers, but this is merely an example, and the hierarchical structure between the scenes may be three or more layers. For example, in the case of a three level hierarchical structure in which a child scene of a certain scene further has a child scene (grandchild scene), an unfold button for displaying the grandchild scene is assigned to a scene button corresponding to the child scene of the certain scene. The same applies to a structure of four or more layers.

### Operator Screen Example 1-2

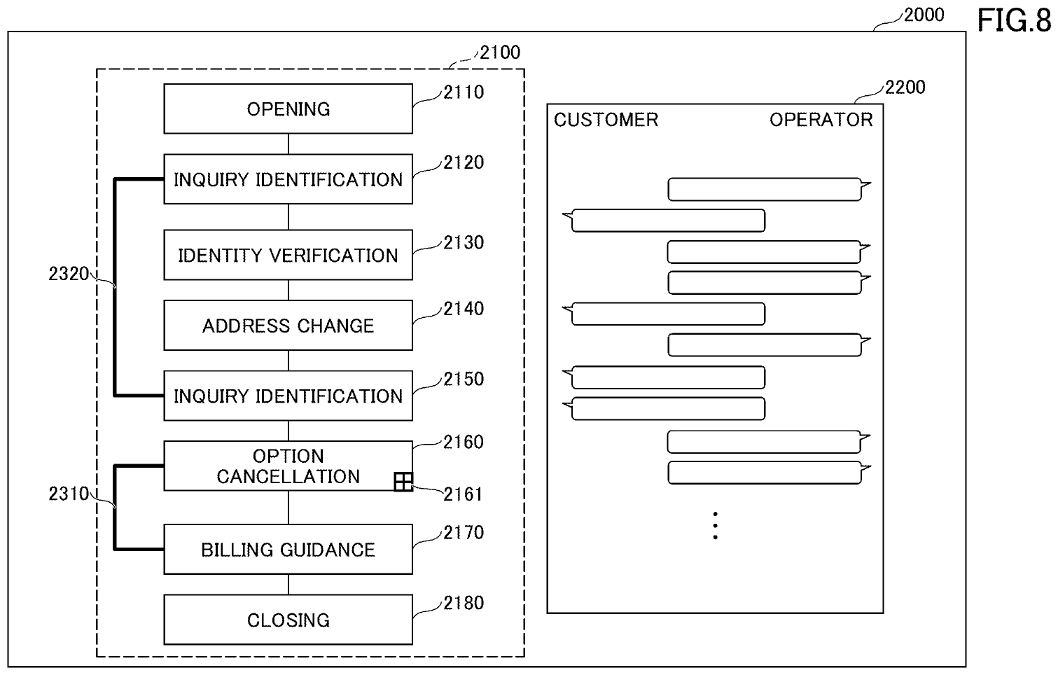

It is assumed that visualization information for visualizing an association between scenes as a relationship between the scenes is generated based on the relationship definition information 111 stored in the relationship definition information storage unit 110. An example of an operator screen displayed by the UI control unit 301 based on the visualization information will be described with reference to FIG. 8.

The operator screen 2000 illustrated in FIG. 8 includes a scene display field 2100 and an utterance display field 2200. The scene display field 2100 displays scene buttons corresponding to scenes specified during a call in chronological order. The utterance display field 2200 displays utterances of a scene corresponding to a scene button selected from the scene display field 2100 in chronological order.

In the example illustrated in FIG. 8, the scene display field 2100 displays a scene button 2110 corresponding to “opening”, a scene button 2120 corresponding to “inquiry identification”, a scene button 2130 corresponding to “identity verification”, a scene button 2140 corresponding to “address change”, a scene button 2150 corresponding to “inquiry identification”, a scene button 2160 corresponding to “option cancellation”, a scene button 2170 corresponding to “billing guidance”, and a scene button 2180 corresponding to “closing”.

The scene button 2160 corresponding to “option cancellation” and the scene button 2170 corresponding to “billing guidance” are connected by a connection line 2310.

This indicates that “option cancellation” and “billing guidance” are associated scenes. The scene button 2160 corresponding to “option cancellation” is provided with an unfold button 2161 for displaying a scene button corresponding to a scene having “option cancellation” as a parent (in other words, a child scene of “option cancellation”).

Further, the scene button 2120 corresponding to “inquiry identification” and the scene button 2150 corresponding to “inquiry identification” are connected by a connection line 2320. This indicates that a plurality of “inquiry identifications” appear.

As described above, in the operator screen according to the present embodiment, when there are associated scenes among the scenes specified during a call (including a case where there are a plurality of the identical scenes), the scenes are connected by the connection line. This enables the operator to easily identify the associated scenes in the scenes of the entire call.

Note that, when there is a scene having a parent-child relationship among the scenes identified during the call and one or more child scenes appear immediately after the parent scene, the child scenes are hidden, and an unfold button for displaying these child scenes is assigned to the scene button corresponding to the parent scene. For example, in the example illustrated in FIG. 8, the unfold button is assigned to the scene button 2160 corresponding to “option cancellation”.

In the example illustrated in FIG. 8, two scenes are associated with each other, but three or more scenes may be associated with each other by a connection line.

### Operator Screen Example 1-3

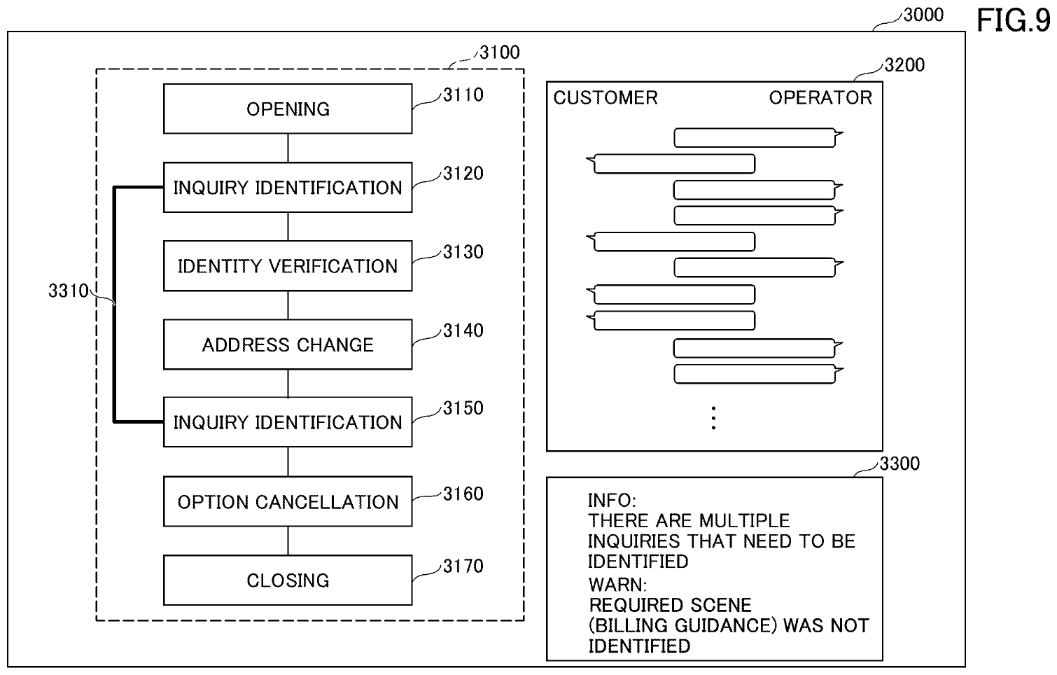

The relationship definition information 111 may define not only the relationship between scenes, but also conditions such as visualizing some information (referred to as supplementary information) when a certain relationship is not satisfied, for example. In the following description, it is assumed that visualization information for visualizing supplementary information is generated when a plurality of identical scenes are present and when one of two scenes in a dependency relationship is not present, in addition to the relationship between the scenes. An example of an operator screen displayed by the UI control unit 301 based on the visualization information will be described with reference to FIG. 9.

The operator screen 3000 illustrated in FIG. 9 includes a scene display field 3100, an utterance display field 3200, and a supplementary information display field 3300. The scene display field 3100 displays scene buttons corresponding to scenes specified during a call in chronological order. The utterance display field 3200 displays utterances of a scene corresponding to a scene button selected from the scene display field 3100 in chronological order. The supplementary information display field 3300 displays supplementary information.

In the example illustrated in FIG. 9, the scene display field 3100 displays a scene button 3110 corresponding to “opening”, a scene button 3120 corresponding to “inquiry identification”, a scene button 3130 corresponding to “identify verification”, a scene button 3140 corresponding to “address change”, a scene button 3150 corresponding to “inquiry identification”, a scene button 3160 corresponding to “option cancellation”, and a scene button 3170 corresponding to “closing”.

Further, the scene button 3120 corresponding to “inquiry identification” and the scene button 3150 corresponding to “inquiry identification” are connected by a connection line 3310. On the other hand, although the scene button 3160 corresponding to “option cancellation” is present, “billing guidance” which is a scene associated with “option cancellation” does not appear.

Therefore, the supplementary information display field 3300 displays supplementary information “There are multiple inquiries that need to be identified” and supplementary information not “Required scene was identified”. In the example illustrated in FIG. 9, the supplementary information is further classified into levels according to the importance of the supplementary information. The supplementary information “There are multiple inquiries that need to be identified” is classified as an INFO level, and the supplementary information “Required scene (Billing Guidance) was not identified” is classified as a WARN level.

As described above, in the operator screen according to the present embodiment, the supplementary information is displayed when the condition defined in the relationship definition information 111 is not satisfied (e.g., when a certain relationship is not satisfied). This enables an operator to easily identify, for example, a case where a plurality of identical scenes are present, a case where a certain scene is not present among a plurality of scenes in the dependency relationship, and the like.

### Summary of First Embodiment

As described above, the contact center system 1 according to the present embodiment displays an operator screen on the operator terminal 30, which allows the operator to easily identify the content of a call after the call with a customer is finished, mainly for the purpose of improving the efficiency of ACW. On this operator screen, in addition to the time series of utterances during the call and the time series of scenes of the utterances, relationships between the scenes (e.g., a hierarchical structure between the scenes, an association between the scenes, and the like), supplementary information, and the like are also visualized. Therefore, the operator can easily identify the contents of the call necessary for the ACW.

Note that, the present embodiment is applied to the case where the operator screen is displayed offline, mainly for the purpose of improving the efficiency of the ACW, but the present embodiment is similarly applicable to an online (i.e., during a call with a customer) case. That is, the relationship between scenes (e.g., a hierarchical structure between scenes, an association between scenes, or the like), supplementary information, or the like described in the present embodiment may be visualized on the operator screen displayed during a call with a customer.

### Modification

In a call with a customer, there is a possibility that the scene transitions to a scene A, subsequently transitions to one or more other scenes, and then transitions to the original scene A. In this case, the scene A is interrupted, and the scene transitions to another one or more scenes, and then the scene A is resumed. In the present modification, it is assumed that the relationship representing that the scene interrupted in the middle is associated with the scene resumed from the interrupted scene is defined at least in the relationship definition information 111.

As a specific example, a case where the scene transitions in the order of (1) to (8) below is exemplified. In this case, it means that “Inquiry Identification (Address Change Request)” of (2) is interrupted and is resumed in (4).
(1) Opening
(2) Inquiry Identification (Address Change Request)
(3) Identity Verification
(4) Inquiry Identification (Address Change Request)
(5) Response (Address Change Response)
(6) Inquiry Identification (Invoice Content Confirmation)
(7) Response (Request Content Confirmation)
(8) Closing

At this time, in the scene display field of the operator screen, the scene button corresponding to (2) “Inquiry Identification (Address Change Request)” and the scene button corresponding to (4) “Inquiry Identification (Address Change Request)” are connected by a connection line.

Note that the “Inquiry Identification (Invoice Content Confirmation)” of (6) and the “Inquiry Identification (Address Change Request)” of (2) and (3) are considered to be scenes having the identical scene “Inquiry Identification” as a parent, for example. Therefore, the scene button corresponding to (6) “Inquiry Identification (Invoice Content Confirmation)”, the scene button corresponding to (2) “Inquiry Identification (Address Change Request)”, and the scene button corresponding to (3) “Inquiry Identification (Address Change Request)” may be connected by a connection line. Alternatively, after the scene buttons (2) and (3) “Inquiry Identification (Address Change Request)” are connected to each other by a connection line, the two scenes connected by the connection line may be connected to the scene button (6) “Inquiry Identification (Invoice Content Confirmation)” by a connection line.

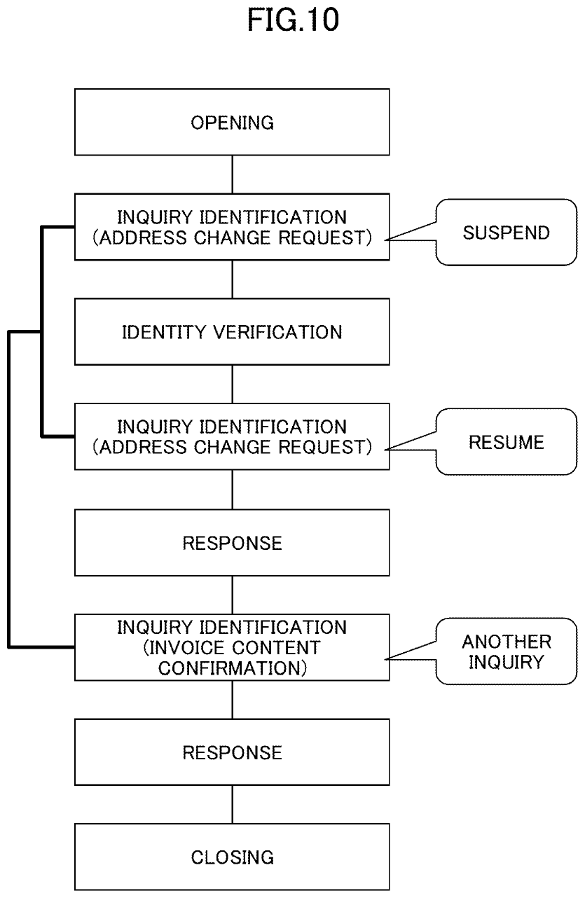

Specifically, when the scene button corresponding to (2) “Inquiry Identification (Address Change Request)” is A1, the scene button corresponding to (3) “Inquiry Identification (Address Change Request)” is A2, the scene button corresponding to (4) “Inquiry Identification (Address Change Request)” is A′, and the connection line is represented by “-”, they may be connected as “A1-A2-A′” or “(A1-A2)-A′”. A specific example of the case where the scene buttons are connected by the connecting line such as “(A1-A2)-A′” is as illustrated in FIG. 10.

### Second Embodiment

Next, a second embodiment will be described. In the present embodiment, a case where an operator screen for supporting identification of a content of a call and a response to a customer is displayed for the purpose of online operator support will be mainly described. Note that, in the following, differences from the first embodiment will be mainly described, and description of the same or similar components as those in the first embodiment will be omitted.

### <Functional Configuration>

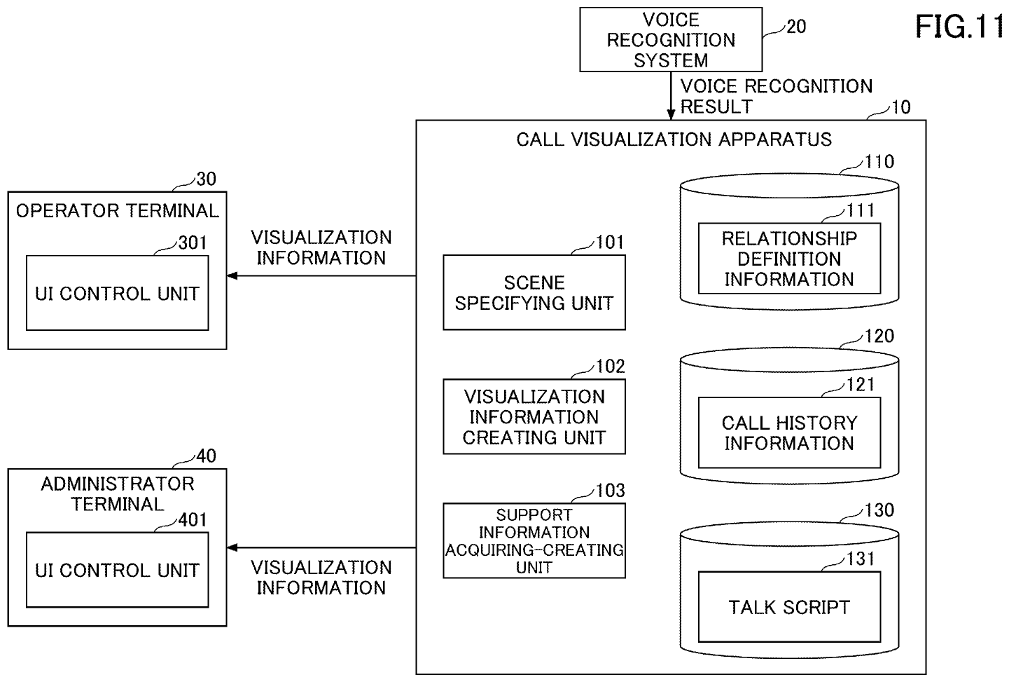

FIG. 11 illustrates functional configurations of the call visualization apparatus 10, the operator terminal 30, and the administrator terminal 40 included in the contact center system 1 according to the present embodiment.

### <<Call Visualization Apparatus 10>>

As illustrated in FIG. 11, the call visualization apparatus 10 according to the present embodiment includes a scene specifying unit 101, a visualization information creating unit 102, and a support information acquiring-creating unit 103. These units are implemented by, for example, a process in which one or more programs installed in the call visualization apparatus 10 are executed by a processor such as a CPU. The call visualization apparatus 10 according to the present embodiment includes a relationship definition information storage unit 110, a call history information storage unit 120, and a talk script storage unit 130. These units can be implemented by a storage unit such as an HDD, an SSD, or a flash memory.

The visualization information creating unit 102 creates visualization information based on the relationship definition information 111 stored in the relationship definition information storage unit 110 and the support information acquired or created by the support information acquiring-creating unit 103. Then, the visualization information creating unit 102 transmits the visualization information to the operator terminal 30 (or the administrator terminal 40). The support information is information for supporting a customer in responding to the customer. In the present embodiment, a talk script 131 and transition probability information to the next scene candidate, which will be described later, are assumed as the support information.

The support information acquiring-creating unit 103 acquires or creates support information based on the current scene specified by the scene specifying unit 101. That is, for example, when the talk script 131 is assumed as the support information, the support information acquiring-creating unit 103 acquires the talk script 131 of the current scene from the talk script storage unit 130. On the other hand, for example, when transition probability information to the next scene candidate is assumed as the support information, the support information acquiring-creating unit 103 generates transition probability information to the next scene candidate with respect to the current scene, based on the call history information 121. Here, since the call history information 121 is time-series information in which a speaker, a text representing the utterance, and the utterance scene are associated with each other, the support information acquiring-creating unit 103 can statistically calculate a transition probability from the current scene to the next scene candidate using a plurality of pieces of call history information 121 stored in the call history information storage unit 120. Therefore, the support information acquiring-creating unit 103 creates the next scene candidate and the transition probability thereof as the support information.

The talk script storage unit 130 stores a talk script 131. The talk script 131 is a collection of model utterances (so-called script) of an operator determined for each scene.

### <Call Visualization Processing>

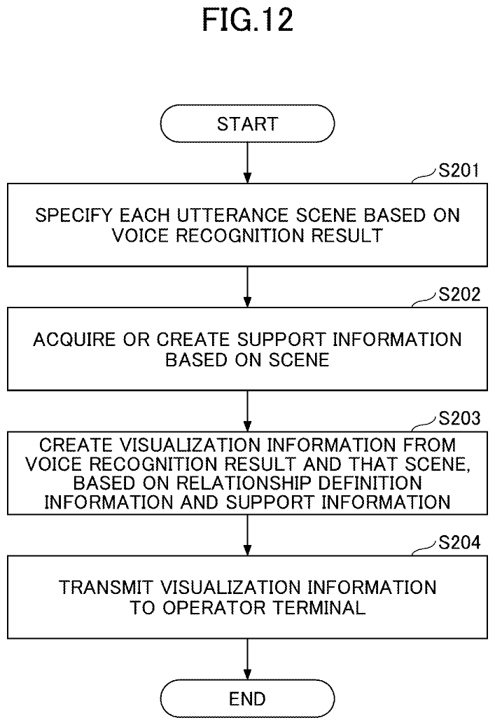

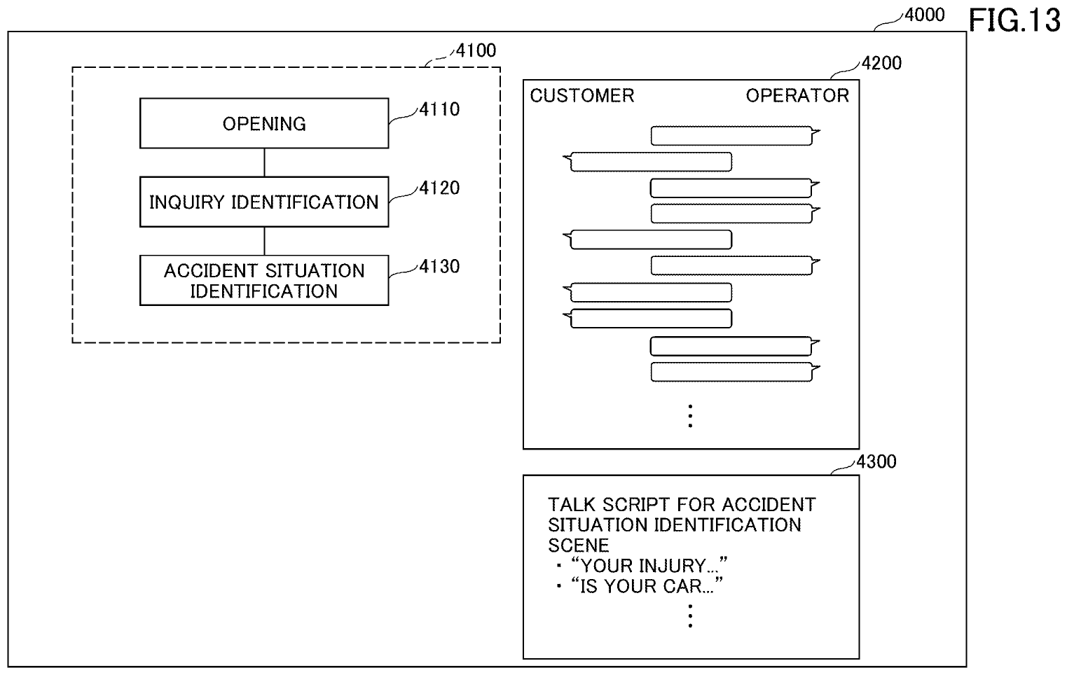

Hereinafter, a process of displaying an operator screen on the display of the operator terminal 30 during a call with a customer and visualizing information for supporting a response to the customer together with the content of the call for the purpose of online operator support will be described with reference to FIG. 12. In the following description, it is assumed that the voice recognition system 20 performs voice recognition on a call between a customer and an operator in real time (e.g., for each utterance), and the voice recognition result is also transmitted to the call visualization apparatus 10 in real time.

First, the scene specifying unit 101 specifies an utterance scene represented by the voice recognition result based on the voice recognition result received from the voice recognition system 20 (step S201).

Next, the support information acquiring-creating unit 103 acquires or creates support information based on a current scene, with the scene specified in step S201 as the current scene (step S202).

Next, the visualization information creating unit 102 creates visualization information based on the relationship definition information 111 stored in the relationship definition information storage unit 110 and the support information acquired or created in step S202 (step S203).

Then, the visualization information creating unit 102 transmits the visualization information created in step S203 to the operator terminal 30 of the operator who is responding to a call (step S204). Accordingly, an operator screen, which will be described later, is displayed on the display of the operator terminal 30 by the UI control unit 301 based on the visualization information received from the call visualization apparatus 10.

In the above-described step S204, the visualization information is transmitted to the operator terminal 30. In addition, for example, the visualization information may be transmitted to the administrator terminal 40 in response to a request from the administrator terminal 40. In this case, a supervisor screen is displayed on the display of the administrator terminal 40 by the UI control unit 401 based on the visualization information received from the call visualization apparatus 10.

### <Operator Screen>

Hereinafter, as an example, an operator screen displayed on the display of the operator terminal 30 will be described.

### Operator Screen Example 2-1

It is assumed that visualization information is created based on the relationship definition information 111 stored in the relationship definition information storage unit 110 and the talk script 131 (support information) of the scene (current scene) specified in step S201. An example of an operator screen displayed by the UI control unit 301 based on the visualization information will be described with reference to FIG. 13.

The operator screen 4000 illustrated in FIG. 13 includes a scene display field 4100, an utterance display field 4200, and a talk script display field 4300. The scene display field 4100 displays scene buttons corresponding to scenes in chronological order every time the scenes are specified during a call. The utterance display field 4200 displays a voice recognition result (text) in the voice recognition system 20 in chronological order every time an utterance is made. The voice recognition result in the voice recognition system 20 is transmitted from the voice recognition system 20 to the operator terminal 30 in real time. The talk script display field 4300 displays a talk script 131 of the current scene (“accident situation identification” in the example illustrated in FIG. 13).

As described above, the talk script 131 of the current scene during a call with a customer is displayed on the operator terminal screen according to the present embodiment. This allows the operator to know contents to be uttered to the customer or contents to be confirmed in the current scene.

In the example illustrated in FIG. 13, the scene buttons displayed in the scene display field 4100 are not provided with the unfold buttons or connected by the connection lines for the sake of simplicity, and as described in the first embodiment, the unfold buttons (or fold buttons) may be provided or connected by the connection lines.

### Operator Screen Example 2-2

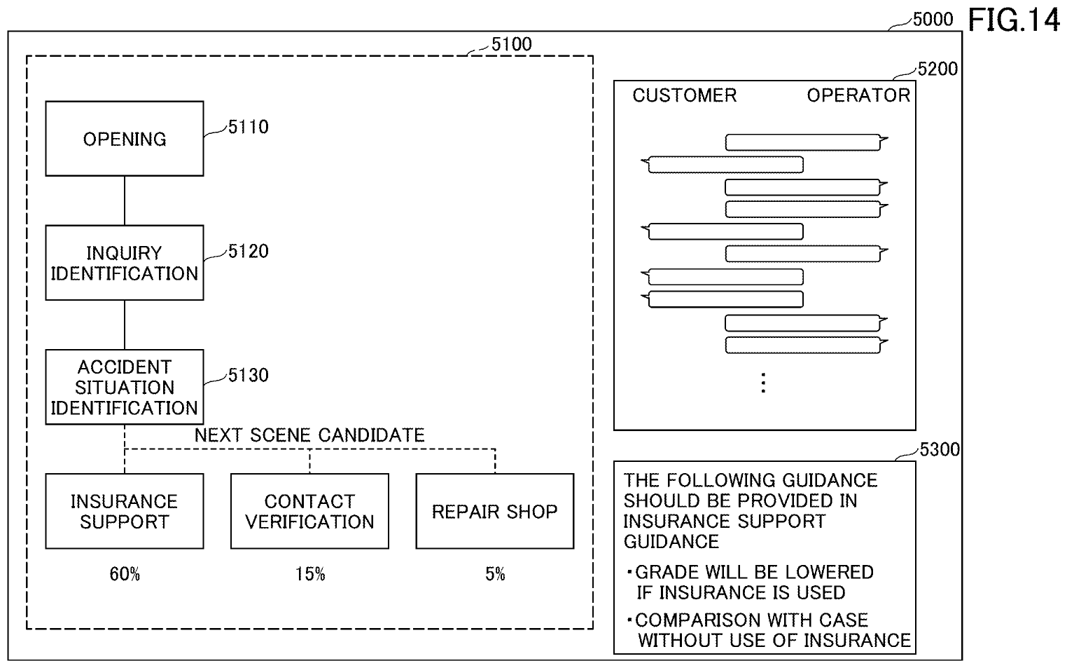

It is assumed that visualization information is created based on the relationship definition information 111 stored in the relationship definition information storage unit 110 and transition probability information (support information) of a scene candidate next to the scene (current scene) specified in step S201. An example of an operator screen displayed by the UI control unit 301 based on the visualization information will be described with reference to FIG. 14.

An operator screen 5000 illustrated in FIG. 14 includes a scene display field 5100 and an utterance display field 5200. The scene display field 5100 displays scene buttons corresponding to scenes in chronological order, and a next scene candidate and a transition probability thereof, every time the scenes are specified during a call. The utterance display field 5200 displays the voice recognition result (text) in the voice recognition system 20 in chronological order every time an utterance is made. The voice recognition result in the voice recognition system 20 is transmitted from the voice recognition system 20 to the operator terminal 30 in real time.

In the example illustrated in FIG. 14, a scene button 5110 corresponding to “opening”, a scene button 5120 corresponding to “inquiry identification”, and a scene button 5130 corresponding to “accident situation identification” which is the current scene are displayed in the scene display field 5100. Further, the next scene candidate “insurance support” and its transition probability “60%”, the next scene candidate “contact verification” and its transition probability “15%”, and the next scene candidate “repair shop” and its transition probability “5%” are displayed. In this example, the top three scene candidates having high transition probabilities and their respective transition probabilities are displayed.

As described above, on the operator screen according to the present embodiment, the next scene candidate of the current scene during a call with a customer is displayed together with the transition probability thereof. This allows the operator to know a scene to which the current scene should be transitioned next.

In the example illustrated in FIG. 14, the scene buttons displayed in the scene display field 5100 are not provided with the unfold buttons or connected by the connection lines, for the sake of simplicity, and as described in the first embodiment, the unfold buttons (or fold buttons) may be provided or connected by the connection lines.

The operator screen 5000 illustrated in FIG. 14 may include an auxiliary information display field 5300 in which auxiliary information such as a point to be noted (e.g., content to be guided to a customer) when the scene candidate is transitioned to the scene candidate having the highest transition probability among the next scene candidates is displayed. This allows the operator to know the points to be noted when the scene is transitioned to the next scene.

Further, although the next scene candidate and the transition probability thereof are displayed on the operator screen 5000 illustrated in FIG. 14, the present invention is not limited to this example, and the operator screen may be displayed in various modes using the transition probability information of the next scene candidate. For example, the next scene candidate may be displayed in a different size, color, or the like according to the transition probability of the next scene candidate, the importance of each scene defined separately, or the like. Further, for example, the transition probability may be classified into a large, medium, and small category, and the next scene candidate and the category of the transition probability may be displayed instead of displaying the transition probability by a value. Further, for example, only the next scene candidate having a transition probability equal to or higher than a predetermined threshold (e.g., 0.3) may be displayed.

Further, in addition to these various modes, for example, whether or not to display the next scene candidate may be set according to the current scene. This is because the next scene of a particular scene may be approximately fixed. As a specific example, since the next scene of “opening” is often “inquiry identification”, it is possible to set that the next scene candidate is not displayed when the current scene is “opening”.

Further, instead of displaying the next scene candidate immediately at the timing of transition to the current scene, the next scene candidate may be displayed after a certain amount of time has elapsed. This is because it is often unnecessary to consider the next scene immediately after the transition to the current scene.

### Summary of Second Embodiment

As described above, the contact center system 1 according to the present embodiment displays an operator screen on the operator terminal 30, which enables the operator to easily identify the content of a call during the call with a customer and to support the customer in answering the customer, mainly for the purpose of online operator support. On this operator screen, the talk script 131 is visualized in real time, and the next scene candidate and the transition probability thereof are visualized. Therefore, the operator can easily determine what utterance should be made online and what customer response should be performed. It is needless to say that both the talk script 131 of the current scene and the next scene candidate of the current scene and the transition probability thereof may be visualized on the operator screen.

The present invention is not limited to the above-described embodiments specifically disclosed, and various modifications, changes, combinations with known techniques, and the like are possible without departing from the scope of the claims.

The present international application is based on and claims priority to Japanese Patent Application No. 2021-166652 filed on Oct. 11, 2021, with the Japanese Patent Office, the entire contents of which are hereby incorporated by reference.

### DESCRIPTION OF THE REFERENCE NUMERALS

1 contact center system
10 call visualization apparatus
20 voice recognition system
30 operator terminal
40 administrator terminal
50 PBX
60 customer terminal
70 communication network
101 scene specifying unit
102 visualization information creating unit
103 support information acquiring-creating unit
110 relationship definition information storage unit
111 relationship definition information
120 call history information storage unit
121 call history information
130 talk script storage unit
131 talk script
301 UI control unit
401 UI control unit
E contact center environment

1. An information processing apparatus comprising a processor configured to execute operations comprising:
specifying a scene, wherein the scene represents a conversation between two or more persons when an utterance is made based on a character string, and the character string represents the utterance in the conversation; and
creating visualization information, wherein the visualization information visualizes a first time series of character strings in the conversation, a second time series of scenes in the conversation, and a relationship between the scenes.

2. The information processing apparatus according to claim 1, the processor further configured to execute operations comprising:
transmitting the visualization information to a terminal connected to the information processing apparatus via a communication network.

3. The information processing apparatus according to claim 1, wherein the creating further comprises creating the visualization information, based on relationship definition information, wherein the relationship definition information defines scenes having a relationship with each other.

4. The information processing apparatus according to claim 3, wherein the relationship definition information comprises a hierarchical structure definition and an association definition, the hierarchical structure definition defines scenes having a parent-child relationship, and the association definition defines scenes having a dependency relationship with each other.

5. The information processing apparatus according to claim 4, wherein when second scenes having a first scene as a parent follow immediately after the first scene in the time series of the scenes, the creating further comprises creating visualization information for hiding the second scenes and adding a component for displaying the second scenes to the first scene in accordance with a selection operation by a user to display the component.

6. The information processing apparatus according to claim 4, wherein the creating further comprises creating visualization information for displaying scenes, the scenes have a dependency relationship with each other by connecting respective scenes of the scenes with a line.

7. The information processing apparatus according to claim 6, wherein the creating further comprises creating visualization information for displaying a predetermined warning when only a part of a plurality of scenes having a dependency relationship is present in the second time series of scenes.

8. The information processing apparatus according to claim 4, wherein when the second time series of scenes include identical scenes, the creating further comprises creating visualization information for displaying the identical scenes by connecting the identical scenes with a line.

9. The information processing apparatus according to claim 1, wherein the creating further comprises creating visualization information for displaying a talk script corresponding to a current scene in the second time series of scenes.

10. The information processing apparatus according to claim 1, wherein the creating further comprises creating visualization information for displaying a candidate for a scene that transitions from a current scene and a transition probability, based on the current scene in the second time series of scenes and previous conversation history information.

11. An information processing apparatus comprising a processor configured to execute operations comprising:
transmitting visualization information to a terminal connected via a communication network, wherein the visualization information is used for visualizing a first time series of character strings, a second time series of scenes, and a relationship between the scenes, the first time series of character strings comprises a character string representing an utterance in a conversation between two or more persons, the second time series of scenes comprises the scene in the conversation.

12. The information processing apparatus according to claim 11, wherein the transmitting further comprises transmitting auxiliary information to the terminal, and the transmitting is sued for visualizing the auxiliary information of to a scene visualized by the visualization information.

13. An information processing method comprising:
specifying, by a processor, a scene in a conversation between two or more persons when an utterance is made, based on a character string representing the utterance in the conversation; and
creating visualization information, wherein the visualization information visualizes a first time series of character strings in the conversation, a second time series of scenes in the conversation, and a relationship between the scenes.

14. A computer-readable non-transitory recording medium storing computer-executable program instructions that when executed by a processor of a computer, execute the information processing method according to claim 13.
